(19) United States
(12) Patent Application Publication
(10) Pub. No.: US 2026/0018342 A1
(43) Pub. Date: Jan. 15, 2026

(54) CAPACITOR AND METHOD OF MANUFACTURING THE SAME

(71) Applicant: TAIYO YUDEN CO., LTD., Tokyo (JP)

(72) Inventors: Kana TAMURA, Tokyo (JP); Yuta SAITO, Tokyo (JP)

(21) Appl. No.: 19/329,054

(22) Filed: Sep. 15, 2025

Related U.S. Application Data
(63) Continuation of application No. PCT/JP2024/003760, filed on Feb. 5, 2024.

(30) Foreign Application Priority Data
Mar. 16, 2023 (JP) 2023-042001

(51) Int. Cl. H01G 4/30; H01G 4/012; H01G 4/232

(52) U.S. Cl. CPC H01G 4/30; H01G 4/012; H01G 4/232

(57) ABSTRACT

One object is to inhibit the reduction of effective capacitance of a capacitor that includes an intermediate layer containing Fe. An aspect of the present disclosure provides a capacitor including a body, a first external electrode provided on the body, and a second external electrode provided on the body. The body includes: a first internal electrode layer; a second internal electrode layer; a dielectric layer disposed between the first and second internal electrode layers; and a first intermediate layer disposed between the first internal electrode layer and the dielectric layer, the first intermediate layer containing Fe at a first concentration. The first concentration is from 0.2 at % to 5 at %. The dielectric layer contains Fe at a second concentration, and the second concentration is less than 1 at %. An Fe concentration ratio, which represents a ratio of the first concentration to the second concentration, is greater than 1.

### CROSS-REFERENCE TO RELATED APPLICATIONS

This is a continuation application of a PCT application No. PCT/JP2024/3760 filed on Feb. 5, 2024, which is based on and claims the benefit of priority from Japanese patent Application serial No. 2023-042001 (filed on Mar. 16, 2023). The contents of the PCT and Japanese applications are hereby incorporated by reference in their entirety.

### TECHNICAL FIELD

The disclosure herein relates mainly to a capacitor and a method of manufacturing the capacitor. The disclosure herein also relates to a circuit module with the capacitor and an electronic device with the circuit module.

### BACKGROUND

As the electronic devices are downsized, there is a need to increase a capacitance generated by capacitors installed in electronic devices without increasing the size of the capacitors. A capacitor has a capacitance-generating portion that includes a dielectric layer and internal electrode layers that sandwich the dielectric layer. Capacitors including thinner dielectric layers can have a larger capacitance without an increase in the size of the capacitors.

However, thinner dielectric layers may reduce the insulation reliability of the capacitors. To address this issue, it has been proposed to improve the insulation reliability of the capacitors by providing intermediate layers containing trace amounts of metallic elements between the dielectric layers and the internal electrode layers, so that the intermediate layers can increase the Schottky barrier between the dielectric layers and the internal electrode layers. For example, Japanese Patent Application Publication No. 2003-7562 (“the '562 Publication”) discloses a capacitor in which intermediate layers containing a metallic element such as Au are provided between dielectric layers and internal electrode layers.

Japanese Patent Application Publication No. 2017-5021 (“the '021 Publication”) discloses that a metallic element is added to an internal electrode layer and that the added metallic element is present at a higher ratio at the interface between the internal electrode layer and a dielectric layer than in a middle region in the thickness direction of the internal electrode layer. The '021 Publication states that the local concentration of the added metallic element at the interface between the internal electrode layer and the dielectric layer causes alloying between Ni, which is the main component of the internal electrode layer, and the added metallic element at the interface. As a result, the capacitor can exhibit improved insulation reliability.

As the metallic elements that can be added to increase the Schottky barrier between the dielectric layers and the internal electrode layers, the '562 Publication discloses Au, Pt, Pd, Ag, and Cu, and the '021 Publication lists Fe, V, Y, and Cu.

The inventor of the present application has placed a focus on Fe, which is inexpensive and easily available, as the metallic element that can be added to increase the Schottky barrier between the dielectric layers and the internal electrode layers.

If intermediate layers containing Fe are formed between the dielectric layers and the internal electrode layers, Fe is likely to diffuse into the dielectric layers. Such incorporation of Fe into the dielectric layers may disadvantageously lead to a decrease in effective capacitance of the capacitor.

The amount of Fe added to the raw material may be reduced. This is expected to result in a reduced proportion of Fe in the dielectric layers, thereby preventing the decrease in effective capacitance. If the amount of Fe added to the raw material is reduced, however, sufficient intermediate layers are not formed between the dielectric layers and the internal electrode layers As a result, the Schottky barrier formed between the dielectric layers and the internal electrode layers may not become high enough to contribute to a significant improvement in the insulation reliability. If sufficient intermediate layers are not formed between the dielectric layers and the internal electrode layers, the capacitor suffers from degraded insulation reliability.

### SUMMARY

It is an object of the present disclosure to solve or alleviate at least part of the drawback mentioned above. Particularly, it is an object of the present disclosure to prevent a decrease in effective capacitance of a capacitor including an Fe-containing intermediate layer. One of the more particular objects of the disclosure is to provide a capacitor that can combine excellent effective capacitance and high insulation reliability. The various inventions disclosed herein may be collectively referred to as “the invention”.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

An aspect of the present disclosure provides a capacitor including a body, a first external electrode provided on the body, and a second external electrode provided on the body. The body includes: a first internal electrode layer; a second internal electrode layer; a dielectric layer disposed between the first and second internal electrode layers in a first direction; and a first intermediate layer disposed between the first internal electrode layer and the dielectric layer, the first intermediate layer containing Fe at a first concentration. The first external electrode is electrically connected to the first internal electrode layer. The second external electrode is electrically connected to the second internal electrode layer. In one aspect, the first concentration is from 0.2 at % to 5 at %. In one aspect, the dielectric layer contains Fe at a second concentration, and in one aspect, the second concentration is less than 1 at %. In one aspect, an Fe concentration ratio, which represents a ratio of the first concentration to the second concentration, is greater than 1.

### Advantageous Effects

According to one embodiment of the disclosure, the decrease in effective capacitance can be inhibited in a capacitor that includes an intermediate layer containing Fe.

### BRIEF DESCRIPTION OF THE DRAWINGS

FIG. 1 is a perspective view schematically showing a capacitor according to one embodiment of the disclosure.

FIG. 2 is a sectional view schematically showing a section of the capacitor of FIG. 1 cut along the line I-I.

FIG. 3 is an enlarged sectional view showing a part of the section shown in FIG. 2 on an enlarged scale.

FIG. 4 shows an example of a line profile obtained by EDS mapping.

FIG. 5 is a flowchart showing a flow of a production method of a capacitor according to one embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the Taxis orthogonal to one another. In this specification, the dimensions, arrangement, shape, and other features of each component of a capacitor 1 may be described with reference to the L, W, and Taxes.

### (1) Capacitor 1

### (1-1) Basic Structure of Capacitor 1

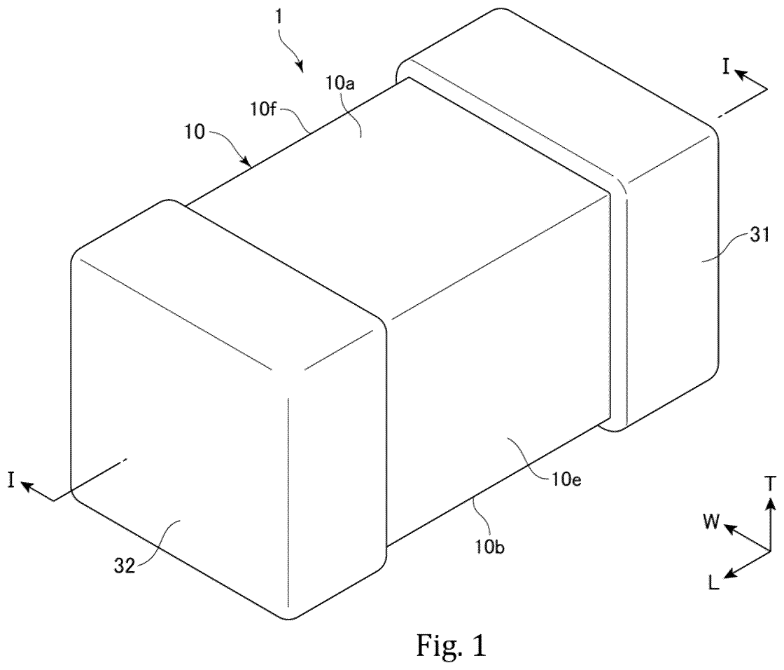

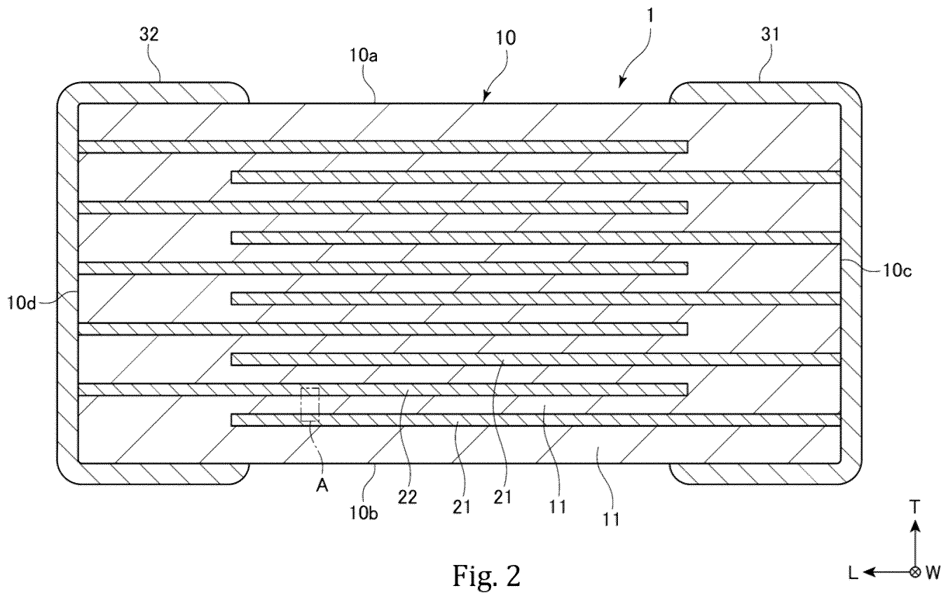

Referring to FIGS. 1 and 2, a description will now be given of the basic structure of a capacitor 1 according to a first embodiment. FIG. 1 is a perspective view showing the capacitor 1 according to the first embodiment. FIG. 2 is a sectional view schematically showing a section of the capacitor 1 cut along the line I-I.

The capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. A dielectric layer 11 is present between a first internal electrode layer 21 and a second internal electrode layer 22 adjacent to the first internal electrode layer 21. The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. The dielectric layers 11 located at the opposite ends in the lamination direction may be referred to as cover layers.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the embodiment shown in FIG. 2, the first internal electrode layer 21 is led from one end in the L-axis direction toward the outside of the body 10. The first internal electrode layer 21 is connected to the first external electrode 31 at one end of the body 10 in the L-axis direction. The second internal electrode layer 22 is led from the other end in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

When voltage is applied between the first and second external electrodes 31 and 32, capacitance is generated between the first and second internal electrode layers 21 and 22.

As will be described later, a first intermediate layer 41 containing Fe is located between the dielectric layer 11 and the first internal electrode layer 21, and a second intermediate layer 42 containing Fe is located between the dielectric layer 11 and the second internal electrode layer 22, but FIGS. 1 and 2 do not show the first intermediate layer 41 and the second intermediate layer 42.

The capacitor 1 may be mounted on an electronic circuit board. The electronic circuit board having the capacitor 1 mounted thereon may be referred to as a circuit module. Various electronic components other than the capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the capacitor 1 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the capacitor 1 may be larger than the width thereof. In one aspect, the width of the capacitor 1 may be larger than the length thereof.

### (1-2) Dielectric Layers 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y} Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may contain one or more additive elements in addition to the main component oxide. In one aspect, the one or more additive elements contained in the dielectric layers 11 are selected from the group consisting of Fe (iron), Ni (nickel), Mo (molybdenum), Nb (niobium), Ta (tantalum), W (tungsten), Mg (magnesium), Mn (manganese), V (vanadium), and Cr (chromium). The dielectric layers 11 may contain two or more of the above additive elements.

The dielectric layers 11 may contain oxides of rare earth elements in addition to the main component oxide. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.02 to 10 μm. The lower limit for the thickness of the dielectric layer 11 may be 0.5 μm. The upper limit for the thickness of the dielectric layer 11 may be 3 μm.

(1-3) First Internal Electrode Layers 21 and Second Internal Electrode Layers 22

In one aspect, the first internal electrode layers 21 contain a base metal such as Ni (nickel), Cu (copper), and Sn (tin), as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more the base metal as the main component thereof. The first internal electrode layers 21 can contain Fe in addition to the main component metal.

The first internal electrode layers 21 can contain additive metal elements in addition to the main component metal and Fe. The additive metal elements that can be contained in the first internal electrode layers 21 are, for example, metals that are more noble than the main component metal of the first internal electrode layers 21. The additive metal elements that can be contained in the first internal electrode layers 21 are one or more elements selected from the group consisting of, for example, Au, Sn, Cr, Y, In (indium), As (arsenic), Co, Cu, Ir (iridium), Mg, Os (osmium), Pd, Pt, Re (rhenium), Rh (rhodium), Ru (ruthenium), Se (selenium), Te (tellurium), W and Zn (zinc).

The description of the components of the first internal electrode layers 21 also applies to the components of the second internal electrode layers 22. The components of the first internal electrode layers 21 and the second internal electrode layers 22 may be either the same or different.

### (1-4) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag (silver), Pd (palladium), Au (gold), Pt (platinum), Ni (nickel), Sn (tin), Cu (copper), W (tungsten), Ti (titanium), and alloys of these.

### (1-5) First Intermediate Layers 41 and Second Intermediate Layers 42

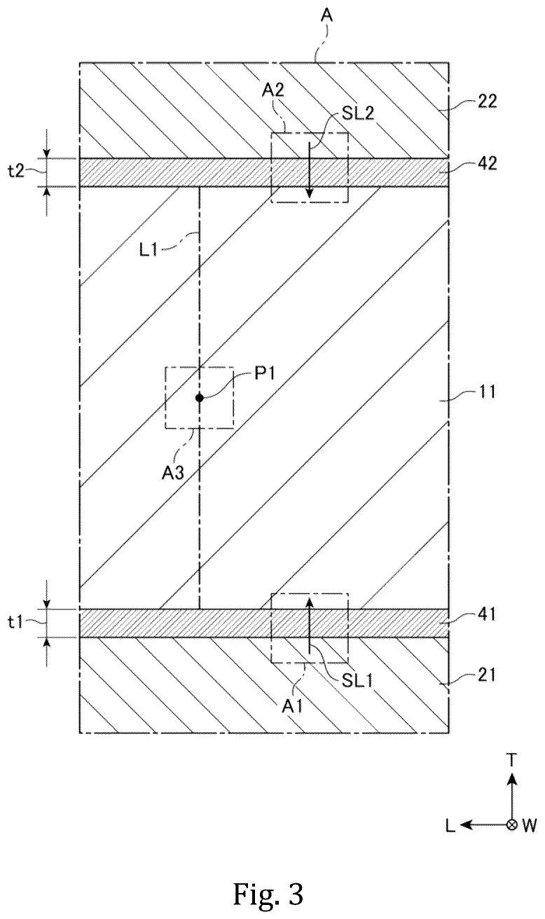

Next, with further reference to FIG. 3, a description is given of the first intermediate layers 41 and the second intermediate layers 42. FIG. 3 is an enlarged sectional view showing, on an enlarged scale, a region A of the section of the body 10 shown in FIG. 2. The region A extends from the first internal electrode layer 21 through the dielectric layer 11 to the second internal electrode layer 22.

The dielectric layers 11 can be made thinner to reduce the size of the capacitor 1. Alternatively, if the dielectric layers 11 are made thinner and the dimension of the capacitor 1 is not altered, the capacitance of the capacitor 1 can be increased by increasing the number of stacked layers. Thus, by making the dielectric layer 11 thinner, one or both of the reduced size and the increased capacitance can be achieved. Therefore, it is desirable to make the dielectric layers 11 thinner.

On the other hand, thinner dielectric layers 11 may reduce the insulation reliability of the capacitor 1. In one aspect, the first intermediate layers 41 are provided between the dielectric layers 11 and the first internal electrode layers 21. The first intermediate layers 41 allow for a higher Schottky barrier to be formed between the dielectric layers 11 and the first internal electrode layers 21. The increased height of the Schottky barrier formed between the dielectric layers 11 and the first internal electrode layers 21 can prevent an increase in leakage current occurring when an electric field is applied, as a result of which the capacitor 1 can achieve improved insulation reliability. In other words, the service life of the capacitor 1 can be extended.

In one aspect, the second intermediate layers 42 containing Fe are provided between the dielectric layers 11 and the second internal electrode layers 22. The second intermediate layers 42 allow for a higher Schottky barrier to be formed between the dielectric layers 11 and the second internal electrode layers 22. The increased height of the Schottky barrier formed between the dielectric layers 11 and the second internal electrode layers 22 can prevent an increase in leakage current occurring when an electric field is applied, as a result of which the capacitor 1 can achieve improved insulation reliability. In other words, the service life of the capacitor 1 can be extended.

In the illustrated embodiment, the body 10 includes the first intermediate layers 41 and the second intermediate layers 42. This configuration allows the Schottky barrier to be increased in both the regions between the dielectric layers 11 and the first internal electrode layers 21 and the regions between the dielectric layers 11 and the second internal electrode layers 22. In one aspect, it is possible that the body 10 includes the first intermediate layers 41 but does not include the second intermediate layers 42. In this case, the Schottky barrier between the dielectric layers 11 and the first internal electrode layers 21 can be increased. In one aspect, it is possible that the body 10 includes the second intermediate layers 42 but does not include the first intermediate layers 41. In this case, the Schottky barrier between the dielectric layers 11 and the second internal electrode layers 22 can be increased.

The first intermediate layer 41 may cover the entire first internal electrode layer 21. The first intermediate layer 41 may cover only a part of the first internal electrode layer 21. The first intermediate layers 41 preferably cover 80% or more of the entire top and bottom surfaces of the first internal electrode layers 21 to reduce leakage current.

The second intermediate layer 42 may cover the entire second internal electrode layer 22. The second intermediate layer 42 may cover only a part of the second internal electrode layer 22. The second intermediate layers 42 preferably cover 80% or more of the entire top and bottom surfaces of the second internal electrode layers 22 to reduce leakage current.

The boundary between the first intermediate layer 41 and the dielectric layer 11 or the first internal electrode layer 21 and the boundary between the second intermediate layer 42 and the dielectric layer 11 or the second internal electrode layer 22 are not necessarily clearly visible in the electron microscope image of the section of the body 10. In addition, the first and second intermediate layers 41 and 42 are not necessarily visible in the electron microscope image due to the limitation of the resolution of the electron microscope. The dielectric layer 11 and the first internal electrode layer 21 can be distinguished using HAADF-STEM (high-angle annular dark-field-scanning transmission electron microscopy). The first and second internal electrode layers 21 and 22 are observed as regions of relatively high brightness in HAADF-STEM because of their higher density compared to the dielectric layer 11.

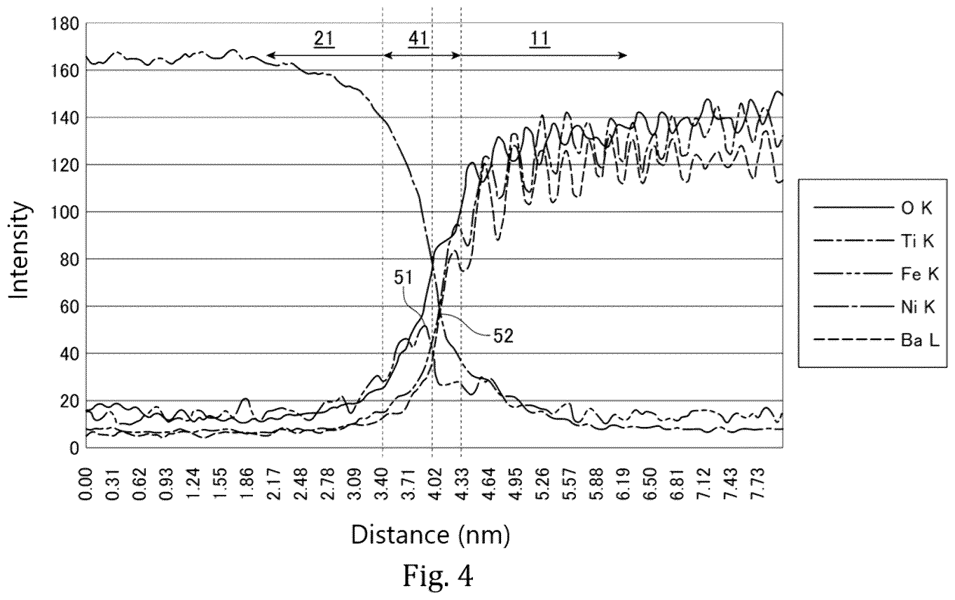

If the first intermediate layers 41 are not visible in electron microscope images, the presence of the first intermediate layers 41 can be confirmed as follows. An observation region A1 extending from a first internal electrode layer 21 to a dielectric layer 11 is set in a section of the body 10 and subjected to TEM-EDS (Transmission Electron Microscope-Energy Dispersive X-ray Spectroscopy) to obtain mapping data of the Fe element. Specifically, the presence of the first intermediate layers 41 can be confirmed by TEM-EDS analysis as follows. (1) An analysis sample is prepared by thinly slicing the body 10 such that a surface parallel to the plane containing the T-axis (e.g., LT plane or WT plane) is exposed as an observation surface, and an observation region A1 spanning from a first internal electrode layer 21 to a dielectric layer 11 is set in the observation surface of the thinly sliced analysis sample. The observation region A1 is subjected to TEM-EDS to obtain mapping data of quantitative elements contained in the analysis sample. The observation region A1 is, for example, a square region with sides of 15 nm. The quantitative elements include the elements contained in the main component oxide of the dielectric layer 11 (e.g., Ba, Ti, and O when the main component oxide is BaTiO₃), the main component metal of the first internal electrode layer 21 (e.g., Ni), and Fe. When observing the analysis sample thinly sliced along the LT plane, the observation surface of the analysis sample is parallel to the section of the body 10 shown in FIG. 3, and therefore, the observation region A1 is depicted in FIG. 3 for convenience of explanation. When observing an analysis sample, a thin slice of the body 10 sliced along the WT plane may be used as the analysis sample. (2) Next, a line analysis is performed based on the obtained mapping data. Specifically, the mapping data of the quantitative elements are subjected to reconstruction along a scanning line SL1 that extends from the first internal electrode layer 21 to the dielectric layer 11, thereby creating line profiles for the quantitative elements. The length of the scanning line SL1 is 8 nm, for example. The length of the scanning line for obtaining the line profiles can be changed appropriately. FIG. 4 shows an example of the line profiles reconstructed along the scanning line SL1 from the mapping data obtained by TEM-EDS in the region A1 of the analysis sample. The line profiles in FIG. 4 are the graphs obtained as follows: an analysis sample is prepared from the capacitor 1 including the dielectric layers 11 that are principally composed of BaTiO₃ and the first internal electrode layers 21 that are principally composed of Ni, and subjected to TEM-EDS to obtain mapping data of the elements including Ba, Ti, O, Ni and Fe, and the mapping data is then used for reconstruction along the scanning line SL1. In FIG. 4, the horizontal axis represents the detection position on the scanning line SL1, and the vertical axis represents the detection intensities calculated based on the counts of Ba, Ti, O, Ni and Fe at the detection positions. (3) If the peak of the line profile of Fe is located in the vicinity of the intersection where the line profile of the non-oxygen element of the main component oxide of the dielectric layer 11 (e.g., Ba) intersects with the line profile of the main component metal element of the first internal electrode layer 21 (hereinafter referred to as “profile intersection”), it can be determined that a first intermediate layer 41 is present in the capacitor 1 from which the analysis sample is taken. For example, if the distance between the position of the profile intersection and the position of the peak of the Fe line profile is equal to or less than a predetermined threshold value, the peak of the Fe line profile can be determined to be in the vicinity of the profile intersection. The predetermined threshold value can be, for example, 1 nm, 0.9 nm, 0.8 nm, 0.7 nm, 0.6 nm or 0.5 nm. In the Fe line profile, when the maximum number of Fe counts in the range of the above threshold value from the profile intersection is 1.5 or more times as large as the average of Fe counts in the region within 2 nm forward and backward from the profile intersection, it can be determined that in the Fe line profile, the peak of Fe is located in the vicinity of the profile intersection.

In the example shown in FIG. 4, the line profile of Ba in BaTiO₃ contained in the dielectric layer 11 as the main component intersects the line profile of Ni contained in the first internal electrode layer 21 as the main component, at the position about 4.1 nm from the scanning start position. In other words, the profile intersection 52 where the Ba line profile intersects the Ni line profile is about 4.1 nm from the scanning start position. Here, the peak 51 of the Fe line profile is located at about 3.9 nm from the scanning start position. Since the peak 51 of the Fe line profile is located about 0.2 nm away from the profile intersection 52, which is less than the threshold value, it is determined that a first intermediate layer 41 is present in the region including the peak 51.

If a peak appears in the Fe line profile, the positions on both sides of the peak of the line profile at which the count value (or the intensity) is half the peak count value (or the peak intensity) can be regarded as the boundary between the first intermediate layer 41 and the dielectric layer 11 and the boundary between the first intermediate layer 41 and the first internal electrode layer 21. The thickness t1 (dimension in the T-axis direction) of the first intermediate layer 41 determined in this manner is, for example, from 0.5 nm to 3.0 nm. The thickness t1 of the first intermediate layer 41 may be from 0.5 nm to 2.0 nm, or from 0.5 nm to 1.3 nm.

### (1-6) Fe Concentration in First Intermediate Layers 41 and Second Intermediate Layers 42

In TEM-EDS, a concentration map is obtained that expresses the concentration of the quantitative element in the observation region A1 in terms of atomic percentage (at %). In one aspect, the concentration of Fe in the first intermediate layer 41 is higher than the concentration of Fe in the dielectric layer 11. The concentration of Fe in the first intermediate layer 41 is herein referred to as the “first concentration.” Since the concentration of Fe varies within the first intermediate layer 41, the concentration of Fe at the peak 51 of the Fe line profile can be taken as the concentration of Fe in the first intermediate layer 41 (i.e., the “first concentration”). Multiple (e.g., ten) observation regions A1 may be set in the analysis sample, and the average of the Fe concentration at the peak of the Fe line profiles obtained in these multiple observation regions A1 may be taken as the first concentration. The first concentration refers to the atomic percentage of Fe at the peak position of the Fe line profile, calculated by taking the total number of atoms of the elements contained in the dielectric layer 11 and the elements contained in the first internal electrode layer 21 as 100 at %. For example, when the dielectric layer 11 is mainly composed of BaTiO₃ and contains Dy as an additive element, and the first internal electrode layer 21 is mainly composed of Ni and contains Fe and Au as additive elements, the first concentration refers to the atomic percentage of Fe, calculated by taking the total number of atoms of Ba, Ti, O, Dy, Ni, Fe, and Au as 100 at %.

When the Fe concentration in the first intermediate layer 41 is insufficient, a small effect results in improving insulation reliability by the Schottky barrier formed between the dielectric layer 11 and the first internal electrode layer 21. Therefore, in one aspect, the lower limit of the first concentration is set at 0.2 at %. The lower limit of the first concentration is preferably 0.3 at %. The lower limit of the first concentration is more preferably 0.8 at %. The lower limit of the first concentration is further preferably 0.9 at %.

On the other hand, when the Fe concentration in the first intermediate layer 41 is excessive, bonding between Fe and the element in the B-site of the oxide as the main component of the dielectric layer 11 is promoted at the interface between the first intermediate layer 41 and the dielectric layer 11, resulting in the occurrence of oxygen defects in the main component oxide of the dielectric layer 11. The oxygen defects in the dielectric layer 11 increase the leakage current and thus cause a decrease in the insulation reliability of the capacitor 1. Therefore, in one aspect, the upper limit of the first concentration is set at 5 at %. The upper limit of the first concentration is preferably 3 at %. The upper limit of the first concentration is further preferably 2 at %.

The range of the first concentration can be determined by appropriately combining the lower and upper limits of the first concentration described above. For example, in one aspect, the first concentration is from 0.2 at % to 5 at %. The first concentration may be from 0.3 at % to 3 at %, or may be from 0.5 at % to 2 at %. Other combinations of the upper and lower limits are also possible.

The above description of the first intermediate layers 41 also applies to the second intermediate layers 42. Specifically, if the second intermediate layers 42 are not visible in electron microscope images, the presence of the second intermediate layers 42 can be confirmed as follows. An observation region A2 extending from a second internal electrode layer 22 to a dielectric layer 11 is set in an observation surface of the thinly sliced analysis sample and subjected to TEM-EDS to obtain mapping data of the Fe element. The observation region A2 is, for example, a square region with sides of 15 nm. The mapping data obtained are subjected to reconstruction along a scanning line SL2 that extends from the second internal electrode layer 22 to the dielectric layer 11, thereby creating line profiles for the quantitative elements. If the peak of the line profile of Fe along the scanning line SL2 is located in the vicinity of the intersection where the line profile of a non-oxygen element of the main component oxide of the dielectric layer 11 (e.g., Ba) along the scanning line SL2 intersects with the line profile of the main component metal element of the second internal electrode layer 22 along the scanning line SL2, it can be determined that a second intermediate layer 42 is present in the analysis sample.

In one aspect, the concentration of Fe in the second intermediate layer 42 is higher than the concentration of Fe in the dielectric layer 11. In this specification, the Fe concentration at the peak of the Fe line profile along the scanning line SL2 may be taken as the Fe concentration in the second intermediate layer 42. Multiple (e.g., ten) observation regions A2 may be set in the analysis sample, and the average of the Fe concentration at the peak of the Fe line profiles obtained in these multiple observation regions A2 may be taken as the Fe concentration of the second intermediate layer 42.

### (1-7) Concentration of Fe in Dielectric Layers 11.

The dielectric layers 11 also contain Fe. The dielectric layers 11 contain Fe at a second concentration. The Fe in the dielectric layers 11 may be derived from the raw material of the dielectric green sheets, which are the precursor of the dielectric layers 11. In other words, Fe may be added to the raw material of the dielectric green sheets. The Fe in the dielectric layers 11 may have been diffused into the dielectric layers 11 (or their precursor) from outside the dielectric layers 11 during the manufacturing process of the capacitor 1.

The Fe contained in the precursor of the dielectric layers 11 is oxidized during the manufacturing process, and the dielectric layer 11 may contain Fe in the form of magnetite (Fe₃O₄). Since Fe₃O₄ is a mixed oxide containing Fe²⁺ and Fe³⁺ hopping of free electrons occurs between the Fe₃O₄ particles contained in the dielectric layers 11. The higher concentration of Fe in the dielectric layers 11 promotes hopping conduction, resulting in a decrease in the insulation resistance of the dielectric layers 11. When the insulation resistance of the dielectric layers 11 decreases, a high electric field is likely to be generated in the first intermediate layers 41 and the second intermediate layers 42-which are located between the first internal electrode layers 21 and the second internal electrode layers 22 and have relatively higher insulation resistance-when a voltage is applied between the first internal electrode layers 21 and the second internal electrode layers 22, thereby increasing the likelihood of leakage current overcoming the Schottky barrier. Therefore, in order to improve the insulation reliability of the capacitor, it is desirable not only to increase the Fe concentrations in the first intermediate layers 41 and the second intermediate layers 42 to increase the Schottky barrier, but also to decrease the Fe concentration in the dielectric layers 11 so that the insulation resistance of the first intermediate layers 41 and the second intermediate layers 42 is not higher than that of the dielectric layers 11. In one aspect, the second concentration representing the concentration of Fe contained in the dielectric layers 11 is lower than the first concentration of Fe in the first intermediate layers 41. In other words, the “Fe concentration ratio,” which represents the ratio of the first concentration of Fe in the first intermediate layers 41 to the second concentration of Fe in the dielectric layers 11, is greater than 1. Assuming the first concentration is C1 and the second concentration is C2, the Fe concentration ratio is expressed as C1/C2. In one aspect, the relationship (C1/C2)>1 is established.

The second concentration of Fe contained in a dielectric layer 11 may refer to the concentration of Fe measured at the midpoint in the T-axis direction of the dielectric layer 11 in a section of the body 10, the section being along a plane including the T-axis direction (e.g., the LT plane or WT plane). The second concentration can be measured, for example, as follows. First, an analysis sample is prepared by thinly slicing the body 10 such that a surface parallel to the plane containing the T-axis (e.g., LT plane) is exposed as an observation surface. This analysis sample may be the same as the thin slice prepared for TEM-EDS on the observation region A1. Next, TEM-EDS is performed on an observation region A3 in the observation surface of the thinly sliced analysis sample to obtain mapping data for the quantitative elements contained in the analysis sample. The observation region A3 is defined so as to include a midpoint P1 of an imaginary line L1 that extends along the T-axis direction from one end to the other end of the dielectric layer 11. The quantitative elements include the elements contained in the main component oxide of the dielectric layer 11 (e.g., Ba, Ti, and O when the main component oxide is BaTiO₃) and Fe. The quantitative elements may additionally include the main component metal element (e.g., Ni) of the first internal electrode layers 21 and the second internal electrode layers 22. The observation surface of the thinly sliced analysis sample is parallel to the section of the body 10 shown in FIG. 3, and therefore, the observation region A3 is depicted in FIG. 3 for convenience of explanation. In TEM-EDS, a concentration map is obtained that expresses the concentration of the quantitative element in the observation region A3 in terms of atomic percentage (at %). Based on this concentration map, the concentration of Fe at the midpoint in the T-axis direction of the dielectric layer 11 (e.g., the midpoint P1 shown in FIG. 3) can be taken as the concentration of Fe in the dielectric layer 11 (i.e., the “second concentration”). Multiple (e.g., ten) observation regions A3 may be set in the analysis sample, and the average of the Fe concentration at the midpoint in the T-axis direction of the dielectric layer 11 obtained in these multiple observation regions A3 may be taken as the second concentration.

The Fe present in the dielectric layers 11 is considered to be dissolved as a solid solution in the main component oxide of the dielectric layers 11, causing oxygen defects in the dielectric layers 11. The oxygen defects in the dielectric layers 11 increase the leakage current and thus cause a decrease in the insulation reliability of the capacitor 1. When the main component oxide of the dielectric layers 11 is represented by the chemical formula ABO₃, Fe is dissolved as a solid solution in the B-site of the main component oxide. Since this Fe inhibits polarization reversal at the B-site, an increase in the Fe content in the dielectric layers 11 results in a decrease in the effective capacitance of the capacitor 1. Therefore, in one aspect, the second concentration of Fe in the dielectric layers 11 is set at less than 1 at %. In one aspect, the upper limit of the second concentration of Fe in the dielectric layers 11 is set at 0.9 at %. The upper limit of the second concentration is preferably 0.5 at %.

### (2) Manufacturing Method of Capacitor 1

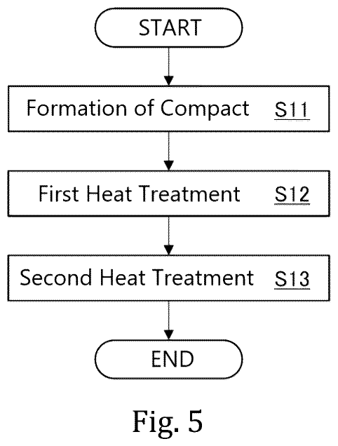

A description will now be given of one example of the manufacturing method of the capacitor 1 with reference to FIG. 5. FIG. 5 is a flowchart showing a flow of a manufacturing method of a capacitor according to one embodiment of the disclosure.

Here is a brief description of the manufacturing method shown in FIG. 5. In step S11, a compact as the precursor of the body 10 is formed. The compact includes dielectric green sheets, which are the precursor of the dielectric layers 11, and internal electrode patterns, which are the precursor of the first and second internal electrode layers 21 and 22. The compact may be formed by alternately stacking dielectric green sheets each having an internal electrode pattern on the surface thereof which is the precursor of the first internal electrode layer 21, and dielectric green sheets each having an internal electrode pattern on the surface thereof which is the precursor of the second internal electrode layer 22. At least one of the dielectric green sheets or the internal electrode patterns contains Fe. Next, in step S12, the compact formed in step S11 is subjected to heat treatment at a first temperature in a low-oxygen atmosphere, thereby forming Fe segregation layers in which Fe is segregated between the dielectric green sheets and the internal electrode patterns. Next, in step S13, the compact having the Fe segregation layers formed therein is heated at a second temperature higher than the first temperature to fire the dielectric green sheets and the internal electrode patterns, so as to obtain the capacitor 1.

The following describes, in more detail, each of the steps of the manufacturing method according to one embodiment with reference to FIG. 5. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain dielectric green sheets. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

The raw powder of the dielectric green sheets may be a mixed powder, which is a mixture of the dielectric powder and additive powder. The additive added to the dielectric powder may be Fe. The mixed powder may be a mixture of the dielectric powder and Fe₂O₃ powder.

Next, an internal electrode pattern is formed on each of the dielectric green sheets formed as described above. The internal electrode pattern is formed, for example, by printing a paste for the internal electrodes on the dielectric green sheet using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is produced by dispersing a metal powder in a binder resin. The metal powder contained in the paste for the internal electrodes encompasses powders of base metals such as Ni, Cu, and Sn, which are the main component of the first and second internal electrode layers 21 and 22. The metal powder contained in the paste for the internal electrodes may be a mixed powder produced by mixing a powder of a base metal such as Ni, Cu, and Sn, which is the main component of the first internal electrode layers 21 and the second internal electrode layers 22, with Fe₂O₃ powder. The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

The internal electrode patterns may be formed on the dielectric green sheets by the sputtering method. The method of forming the internal electrode patterns is not limited to those specified herein. The internal electrode patterns may be formed by various known methods, e.g., vacuum deposition, pulsed laser deposition (PLD), metal organic chemical vapor deposition (MO-CVD), metal organic decomposition (MOD), or chemical solution deposition (CSD).

When forming the internal electrode patterns by the sputtering method, a conductor target containing base metals such as Ni, Cu, and Sn is sputtered under predetermined film-forming conditions, and the sputtered particles generated at this time are deposited on the dielectric green sheets. The conductor target may contain Fe as well as base metals.

Both the dielectric green sheet and the internal electrode pattern may contain Fe, or only one of the dielectric green sheet and the internal electrode pattern may contain Fe.

An intermediate film containing a higher concentration of Fe than the dielectric green sheet and the internal electrode pattern may be formed between the dielectric green sheet and the internal electrode pattern. The intermediate film may be formed by depositing sputtered particles onto the surface of the dielectric green sheet through sputtering of a target containing Fe and a non-metallic element that is the main component metal of the internal electrode pattern. By forming the internal electrode pattern on the intermediate film that is formed on the dielectric green sheet, the intermediate film is sandwiched between the dielectric green sheet and the internal electrode pattern. In the case where an intermediate film containing a high concentration of Fe is formed, it is not necessary for the raw materials of either the dielectric green sheet or the internal electrode pattern to contain Fe.

Next, the dielectric green sheet with an internal electrode pattern formed on the surface thereof is removed from the substrate film. The dielectric green sheets each having an internal electrode pattern formed on the surface thereof are prepared in this way, and a predetermined number of such dielectric green sheets are stacked and thermocompressed to obtain a laminate. The top layer and the bottom layer of the laminate may be formed of green sheets that do not have internal electrode patterns formed thereon. The laminate may include the intermediate films containing a high concentration of Fe formed between the dielectric green sheets and the internal electrode patterns.

Next, the laminate is diced into pieces to obtain chip compacts each being the precursor of the body 10. The chip compacts may be subjected to a degreasing process. The degreasing process may be performed in an N₂ atmosphere. The compacts having undergone the degreasing process may be coated with a metal paste by the dip method to form base layers for the first and second external electrodes 31 and 32.

Next, in step S12, the chip compact produced in step S11 is subjected to the first heat treatment. Specifically, the first heat treatment is performed according to the following heating conditions.
Atmosphere: low-oxygen atmosphere (oxygen partial pressure of 10-9 to 10-10 atm)
First heating temperature: 500 to 700° C.
Heating time: 10 minutes to 1 hour

If the internal electrode patterns in the compact contain Fe, the first heat treatment performed under the heating conditions described above causes Fe in the internal electrode patterns to thermally diffuse toward the interfaces with the dielectric green sheets, forming Fe segregation layers containing much Fe at the interfaces between the internal electrode patterns and the dielectric green sheets.

If the dielectric green sheets in the compact contain Fe, the first heat treatment performed under the heating conditions described above causes Fe in the internal electrode patterns to thermally diffuse toward the interfaces with the internal electrode patterns, forming Fe segregation layers containing much Fe at the interfaces between the internal electrode patterns and the dielectric green sheets.

In the case where the intermediate films are provided between the dielectric green sheets and the internal electrode patterns within the compact, Fe thermally diffuses from the intermediate films toward the dielectric green sheets and the internal electrode patterns during the first heat treatment. Through the first heat treatment, the intermediate films within the compact are formed into the Fe segregation layers.

The Fe segregation layers formed in the above manner is the precursor of the first and second intermediate layers 41 and 42.

Next, in step S13, the compact having undergone the first heat treatment in step S12 is subjected to the second heat treatment at a second heating temperature higher than the first heating temperature to fire the compact, so as to obtain the capacitor 1. Through the second heat treatment, the dielectric green sheets in the compact are fired to form the dielectric layers 11, the internal electrode patterns are fired to form the first internal electrode layers 21 and the second internal electrode layers 22, and the Fe segregation layers are fired to form the first intermediate layers 41 and the second intermediate layers 42. The base layers of the metal paste formed on the surface of the compact form the first external electrode 31 and the second external electrode 32.

The second heat treatment on the compact is performed according to the following heating conditions.
Atmosphere: low-oxygen atmosphere (oxygen partial pressure of 10-9 to 10-10 atm)
Second heating temperature: 1100 to 1300° C.
Heating time: 10 minutes to 1 hour

In the second heat treatment, the compact is heated at a high temperature of about 1100 to 1300° C., which causes thermal diffusion of Ni contained in the internal electrode patterns. However, since the Fe segregation layers are formed between the internal electrode patterns and the dielectric green sheets during the first heat treatment, the Fe segregation layers inhibit the thermal diffusion of Ni from the internal electrode patterns to the dielectric green sheets. The Ni diffused into the dielectric green sheets is dissolved as a solid solution in the B-site of the main component oxide represented by the chemical formula ABO₃ in the dielectric layers 11 after firing, thereby generating oxygen defects in the dielectric layers 11. The oxygen defects in the dielectric layers 11 increase the leakage current and thus cause a decrease in the insulation reliability of the capacitor 1. Since Ni dissolved as a solid solution in the B-site of the main component oxide of the dielectric layers 11 inhibits polarization reversal at the Ti-site, an increase in the Ni content in the dielectric layers 11 results in a decrease in the effective capacitance of the capacitor 1. According to the above manufacturing method, thermal diffusion into the dielectric green sheets is inhibited by the Fe segregation layers formed during the first heat treatment. As a result, compared to conventional manufacturing methods in which no Fe segregation layer is formed prior to the second heat treatment (firing), the Ni content in the fired dielectric layers 11 can be smaller. Thus, the above manufacturing method can improve the insulation reliability and effective capacitance of the capacitor 1.

In the second heat treatment, the temperature should desirably be increased at a high rate to the above heating temperature. The temperature increase rate in the second heat treatment is 1.5 to 5 times as high as the temperature increase rate in the first heat treatment. The temperature increase rate in the second heat treatment is, for example, 5,000° C./h to 10,000° C./h. In the second heat treatment, the high rate of increasing the temperature to the heating temperature can inhibit the diffusion of Fe. The Fe diffused into the dielectric green sheets is dissolved as a solid solution in the B-site of the main component oxide represented by the chemical formula ABO₃ in the dielectric layers 11 after firing, thereby generating oxygen defects in the dielectric layers 11. The Fe dissolved as a solid solution in the B-site of the main component oxide of the dielectric layers 11 inhibits polarization reversal at the Ti-site. Therefore, an increase in the Fe content in the dielectric layers 11 results in a decrease in the insulation reliability and effective capacitance of the capacitor 1. According to the above manufacturing method, since the temperature is increased at a high rate to the second heating temperature in the second heat treatment, thermal diffusion of Fe from the Fe segregation layers into the dielectric green sheets can be inhibited. Thus, the above manufacturing method can improve the insulation reliability and effective capacitance of the capacitor 1.

Processes not shown in the flowchart of FIG. 5 may be performed to produce the capacitor 1. For example, the capacitor 1 obtained through the second heat treatment in step S13 may be subjected to re-oxidation treatment at 600° C. to 1000° C. in an N₂ gas atmosphere. A plating layer of Cu, Ni, Sn or the like may be provided on the surfaces of the first and second external electrodes 31 and 32. This plating layer can be formed by the electrolytic or electroless plating method.

(3) Examples

The invention will now be further described in detail based on examples. The invention is not limited to the following examples.

First, 29 different samples were prepared according to the manufacturing method shown in FIG. 5, as follows. To prepare these samples, powders of barium titanate as the main component oxide of the dielectric layers 11, a rare-earth element oxide (e.g., HO₂O₃), MgO, and Fe₂O₃ were prepared. Then, 0.8 mol parts of rare earth oxide, 0.1 mol parts of MgO, and Fe₂O₃ powder in the proportions shown in Tables 1A to 1C were weighed relative to 100 mol parts of barium titanate powder. “N/A” indicates that no Fe₂O₃ powder was added. For example, in Sample 1, no Fe₂O₃ powder was added to the dielectric green sheets. These weighed powders were mixed and ground using zirconia beads having a diameter of 1 mm, to obtain the raw powder for the dielectric green sheets corresponding to samples 1 to 29.

Next, for each of the raw powders for the dielectric green sheets used to prepare samples 1 to 29, polyvinyl butyral (PVB) resin, a solvent, and a plasticizer were added and wet-mixed to obtain 29 different slurries for dielectric green sheets. Each of these slurries was coated on a substrate film, and then the slurry coated on the substrate film was dried to obtain 29 types of dielectric green sheets.

Next, powders of Ni and Fe₂O₃ were prepared individually. Then, the Fe₂O₃ powder was weighed in the proportions shown in Tables 1A to 1C, relative to 100 mol parts of Ni powder. In Tables 1A to 1C, “N/A” indicates that no Fe₂O₃ powder was added. These weighed powders were mixed and ground using zirconia beads having a diameter of 1 mm, to obtain the raw powder for the internal electrode patterns corresponding to samples 1 to 29.

Next, for each of the raw powders of the paste for the internal electrodes used to prepare samples 1 to 29, polyvinyl butyral (PVB) resin, a solvent, and a plasticizer were added and wet-mixed to obtain the slurry for the internal electrodes. Then, each slurry for the internal electrodes was printed on the corresponding dielectric green sheet, to form an internal electrode pattern on each dielectric green sheet. In this way, 29 types of dielectric green sheets each having the internal electrode pattern on the surface thereof were obtained.

Next, 500 dielectric green sheets for each sample were stacked together to form a laminate, which was then diced into chip compacts. The chip compacts had the 1005 shape (length: 1.0 mm, width: 0.5 mm, height: 0.5 mm). Next, these chip compacts were degreased in an N₂ atmosphere. Following this, metal paste was applied to the degreased compacts by the dip method, to form base layers of the external electrodes on the compacts.

Next, each of the 29 types of chip compacts obtained as described above was subjected to the first heat treatment at 500° C. for the first heating time shown in Tables 1A to 1C below in a low-oxygen atmosphere with an oxygen partial pressure of 10-9 to 10-10 atm.

TABLE 1A

| | | Fe₂O₃ Powder | |
|---|---|---|---|
| | Fe₂O₃ Powder | Content in | First |
| | Content in | Internal | Heating |
| Sample | Dielectric | Electrode | Time |
| No. | Raw Powder | Raw Powder | (min) |
| Sample 1 | N/A | N/A | 10 |
| Sample 2 | N/A | 0.02 | 20 |
| Sample 3 | N/A | 0.02 | 10 |
| Sample 4 | N/A | 0.03 | 20 |
| Sample 5 | N/A | 0.04 | 10 |
| Sample 6 | N/A | 0.06 | 10 |
| Sample 7 | N/A | 0.11 | 10 |
| Sample 8 | 0.50 | 0.21 | 40 |
| Sample 9 | 2.00 | N/A | 60 |
| Sample 10 | 0.21 | 0.13 | 20 |

TABLE 1B

| | | Fe₂O₃ Powder | |
|---|---|---|---|
| | Fe₂O₃ Powder | Content in | First |
| | Content in | Internal | Heating |
| Sample | Dielectric | Electrode | Time |
| No. | Raw Powder | Raw Powder | (min) |
| Sample 11 | 1.00 | 0.13 | 60 |
| Sample 12 | N/A | 0.21 | 10 |
| Sample 13 | N/A | 0.21 | 20 |
| Sample 14 | 0.11 | 0.21 | 30 |
| Sample 15 | 0.42 | 0.13 | 30 |
| Sample 16 | 0.12 | 0.19 | 20 |
| Sample 17 | N/A | 0.21 | 10 |
| Sample 18 | N/A | 0.42 | 10 |
| Sample 19 | 0.21 | 0.42 | 20 |
| Sample 20 | 0.32 | 0.42 | 30 |

TABLE 1C

| | | Fe₂O₃ Powder | |
|---|---|---|---|
| | Fe₂O₃ Powder | Content in | First |
| | Content in | Internal | Heating |
| Sample | Dielectric | Electrode | Time |
| No. | Raw Powder | Raw Powder | (min) |
| Sample 21 | 0.63 | 0.55 | 50 |
| Sample 22 | 2.00 | 0.42 | 60 |
| Sample 23 | N/A | 0.63 | 10 |
| Sample 24 | 0.11 | 0.63 | 20 |
| Sample 25 | 1.50 | 0.85 | 50 |
| Sample 26 | N/A | 1.06 | 10 |
| Sample 27 | N/A | 1.06 | 20 |
| Sample 28 | 0.51 | 1.06 | 50 |
| Sample 29 | 1.00 | 1.28 | 40 |

Next, each of the 29 types of compacts having undergone the first heat treatment was heated while increasing the temperature to 1200° C. at 6000° C./h and heated at 1200° C. for 30 minutes, in a low-oxygen atmosphere with an oxygen partial pressure of 10-9 to 10-10 atm.

Samples 1 to 29 were prepared as described above. In samples 1 to 29, the dielectric green sheets were fired to form the dielectric layers, and the internal electrode patterns were fired to form the internal electrode layers. The base layers formed on the compacts were fired to form the external electrodes. Therefore, samples 1 to 29 are all capacitors in which the dielectric layers and internal electrode layers are arranged alternately along the T-axis direction.

Next, each of samples 1 to 29 was sliced using a focused ion beam (FIB) system so that the LT surface can be the observation surface, and a sliced analysis sample with a thickness of 60 nm was taken from each of samples 1 to 29. Damage that appeared on the observation surfaces of the sliced samples was removed as appropriate by Ar ion milling. Since the observation surfaces of the sliced samples correspond to the section shown in FIG. 3, the following description about the observation region and the scanning lines will be made with reference to FIG. 3 for convenience of explanation.

Next, each of the sliced samples was placed in a TEM equipped with an EDS detector, and a TEM image of the observation surface of the sliced sample was acquired. The contrast difference in the TEM image was used to identify the dielectric layers and the internal electrode layers. The TEM used was the JEM-ARM200F NEOARM, an atomic-resolution analytical electron microscope from JEOL Ltd. The EDS detector used was the DrySD 160 detector Dual SDD system from JEOL Ltd. Next, ten observation regions A1 (each corresponding to the observation region A1 in FIG. 3) of 15 nm square extending from an internal electrode layer to a dielectric layer were set and subjected to EDS analysis. In addition, ten observation regions A3 (each corresponding to the observation region A3 in FIG. 3), each including the midpoint of the dielectric layer in the lamination direction (T-axis direction) (corresponding to point P1 in FIG. 3), were set, and EDS analysis was performed on each of these ten observation regions A3 within the dielectric layer. The DrySD160 detector Dual SDD system from JEOL Ltd. was used for the EDS analysis. The EDS was performed under the conditions of an acceleration voltage of 200 kV, a spot size of 6C, and a measurement time of 30 minutes.

Through the EDS, concentration maps representing the concentrations of the quantitative elements in atomic ratio (at %) were obtained for each of the ten observation regions A1, and the concentration maps were reconstructed along a scanning line extending along the T-axis from the internal electrode layer to the dielectric layer within each observation region A1. In this way, the line profile of Fe was obtained for each observation region A1. The average of the Fe concentration at the peak of the Fe line profiles of the observation regions A1, obtained in this manner, was taken as the first concentration for each sample. In the case where no peak was found in the Fe line profile of the observation region A1 (samples 1, 2, and 8), the Fe concentration at the position of the profile intersection point 52 at which the Ba and Ni line profiles intersect was taken as the first concentration.

Through the EDS, concentration maps representing the concentrations of the quantitative elements in atomic ratio (at %) were obtained for each of the ten observation regions A3. Based on these concentration maps, the Fe concentration at the midpoint of the dielectric layer in the T-axis direction, located in the observation region A3, was determined. The average of Fe concentration at the midpoint of the dielectric layer within the observation regions A3, obtained in this manner, was taken as the second concentration for each sample. The first concentration (C1) and the second concentration (C2) of each sample determined as described above are shown in Tables 2 to 4. In TEM analysis, Fe is detected as system noise, and therefore, the concentrations shown in Tables 2 to 4 represent values from which system noise is subtracted.

Next, ten samples were selected for each of samples 1 to 29, and a capacitance test was performed on each of these selected samples. First, for each sample, the capacitance (Cap1) under a DC bias voltage of 0 Vdc was measured using an LCR meter. The AC bias voltage was set to 1 Vrms at 1 KHz. Next, for each sample, the capacitance (Cap2) was measured under a DC bias voltage of 3 Vdc, while keeping all other measurement conditions unchanged. For each of samples 1 to 29, the rate of change in capacitance due to the application of a DC voltage was calculated based on the following Equation (1), using the measured Cap1 and Cap2 values from the ten samples.

$$Capacitance change rate = 100 \times ( ( Cap 2 ) - ( Cap 1 ) ) / ( Cap 1 ) \qquad ( 1 )$$

For each of samples 1 to 29, the average capacitance change rate calculated from the ten samples is shown in the column “Average Effective Capacitance” of Tables 2 to 4. In capacitors, the effective capacitance should preferably be −35% or more, particularly −25% or more. In other words, in capacitors, the rate of change in capacitance due to the application of a DC voltage should preferably be 35% or less, particularly 25% or less. A capacitor with a capacitance change rate of 35% or less under the application of a 3 V DC voltage can be evaluated as having excellent effective capacitance. Furthermore, a capacitor with a capacitance change rate of 25% or less under the application of a 3 V DC voltage can be evaluated as having particularly excellent effective capacitance.

Next, ten samples were selected for each of samples 1 to 29, and an accelerated life test (HALT) was performed on each of these selected samples. In the accelerated life test, for each of samples 1 to 29, the life of each of the ten selected samples was determined while a voltage of 30 V/μm was applied under 125° C., and the average failure time was calculated by averaging the lives determined for these ten samples. The values obtained by rounding the tens digit of the average failure time for each sample, as determined in this manner, are shown in the column “Average Failure Time” of Tables 2 to 4. In capacitors, it is desirable for the life determined by an accelerated life test to be 2,000 minutes or more, particularly 4,000 minutes or more. A capacitor with a life of 2,000 minutes or more, as determined by an accelerated life test, can be evaluated as having excellent insulation reliability. Furthermore, a capacitor with a life of 4,000 minutes or more, as determined by an accelerated life test, can be evaluated as having particularly excellent insulation reliability.

In Tables 2 to 4, the samples not encompassed by the present invention (i.e., comparative examples) have an asterisk (*) added to the sample number. Specifically, samples 1 to 4, 8, 9, 11, 22, 25, and 29 are comparative examples not encompassed by the present invention.

TABLE 2

| | First | Second | | Average | Average |
|---|---|---|---|---|---|
| Sample | Concentration | Concentration | | Effective | Failure |
| No. | C1 (at %) | C2 (at %) | C1/C2 | Capacitance | Time |
| Sample 1* | 0.00 | 0.00 | — | −20% | 800 |
| Sample 2* | 0.10 | 0.10 | 1 | −20% | 1000 |
| Sample 3* | 0.10 | 0.01 | 10 | −20% | 1000 |
| Sample 4* | 0.15 | 0.10 | 1.5 | −21% | 1000 |
| Sample 5 | 0.20 | 0.10 | 2 | −21% | 3500 |
| Sample 6 | 0.30 | 0.10 | 3 | −21% | 4000 |
| Sample 7 | 0.50 | 0.20 | 2.5 | −21% | 4500 |
| Sample 8* | 0.50 | 0.50 | 1 | −25% | 1500 |
| Sample 9* | 0.50 | 1.20 | 0.4 | −48% | 700 |

TABLE 3

| | First | Second | | Average | Average |
|---|---|---|---|---|---|
| Sample | Concentration | Concentration | | Effective | Failure |
| No. | C1 (at %) | C2 (at %) | C1/C2 | Capacitance | Time |
| Sample 10 | 0.60 | 0.40 | 1.5 | −24% | 4700 |
| Sample 11* | 0.70 | 0.90 | 0.8 | −34% | 800 |
| Sample 12 | 0.80 | 0.30 | 2.7 | −22% | 5000 |
| Sample 13 | 0.80 | 0.40 | 2 | −24% | 6200 |
| Sample 14 | 0.80 | 0.50 | 1.6 | −25% | 6000 |
| Sample 15 | 0.80 | 0.60 | 1.3 | −26% | 5800 |
| Sample 16 | 0.90 | 0.30 | 3 | −22% | 7500 |
| Sample 17 | 1.00 | 0.10 | 10 | −24% | 8000 |

TABLE 4

| | First | Second | | Average | Average |
|---|---|---|---|---|---|
| Sample | Concentration | Concentration | | Effective | Failure |
| No. | C1 (at %) | C2 (at %) | C1/C2 | Capacitance | Time |
| Sample 18 | 2.00 | 0.10 | 20 | −22% | 5000 |
| Sample 19 | 2.00 | 0.40 | 5 | −25% | 7000 |
| Sample 20 | 2.00 | 0.50 | 4 | −25% | 5000 |
| Sample 21 | 2.00 | 0.80 | 2.5 | −32% | 4000 |
| Sample 22* | 2.00 | 1.30 | 1.5 | −50% | 3000 |
| Sample 23 | 3.00 | 0.20 | 15 | −26% | 2300 |
| Sample 24 | 3.00 | 0.40 | 7.5 | −24% | 3000 |
| Sample 25* | 3.00 | 1.00 | 3 | −41% | 2000 |
| Sample 26 | 5.00 | 0.10 | 50 | −23% | 2500 |
| Sample 27 | 5.00 | 0.40 | 12.5 | −24% | 2200 |
| Sample 28 | 5.00 | 0.90 | 5.6 | −35% | 2000 |
| Sample 29* | 6.00 | 0.90 | 6.7 | −35% | 1000 |

In samples 1 to 4 (all comparative examples), the average failure time is short, ranging from 800 to 1000 minutes. It is considered that the short average failure time observed in samples 1 and 2 is due to the absence of intermediate layers containing Fe between the dielectric layers and the internal electrode layers. In sample 1, the first concentration is 0 at %, and thus no intermediate layer with segregated Fe is present. In sample 2, the first concentration is 0.1 at %, which is the same as the second concentration, and thus it is considered that Fe is uniformly distributed throughout the body, and no intermediate layer with segregated Fe is present between the dielectric layers and the internal electrode layers.

In samples 5 to 7 (all examples), the average effective capacitance is particularly high at −21%, and the average failure time is long, ranging from 3,500 to 4,500 minutes. Thus, in samples 5 to 7, both excellent effective capacitance and excellent insulation reliability are achieved. The high average effective capacitance in samples 5 to 7 is considered to be achieved by the low second concentration-0.1 at % or 0.2 at %-in these samples, indicating that only a small amount of Fe is dissolved as a solid solution in the BaTiO₃ of the dielectric layers. The long average failure time is considered to be achieved by: (1) the first concentration being high, ranging from 0.2 at % to 0.5 at %, which increases the Schottky barrier by the first intermediate layers 41 formed between the dielectric layers 11 and the first internal electrode layers 21 in samples 5 to 7; and (2) the Fe concentration ratio of the first concentration to the second concentration (C1/C2) being greater than 1, which prevents a strong electric field from being generated in the first intermediate layers 41 between the dielectric layers 11 and the first internal electrode layers 21 when voltage is applied.

In sample 8 (comparative example) and sample 11, the average failure time is short, at 1,500 minutes and 800 minutes, respectively. The short average failure time in samples 8 and 11 is considered to be due to the fact that, in sample 8, the first concentration is equal to the second concentration (i.e., the Fe concentration ratio is 1), and in sample 11, the second concentration is higher than the first concentration; as a result, in both samples, a strong electric field is generated in the intermediate layers formed between the dielectric layers and the internal electrode layers.

In sample 9 (comparative example), the average effective capacitance is low at −45%, and the average failure time is short at 700 minutes. The low average effective capacitance in sample 9 is considered to be due to the second concentration being high at 1.2 at % in sample 9, indicating that a large amount of Fe is dissolved as a solid solution in the BaTiO₃ of the dielectric layers. The short average failure time in sample 9 is considered to be due to the fact that the first concentration is equal to the second concentration (i.e., the Fe concentration ratio is 1), and thus a strong electric field is generated in the intermediate layers formed between the dielectric layers and the internal electrode layers.

In sample 10 (example), the average effective capacitance is particularly high at −24%, and the average failure time is particularly excellent at 4500 minutes. Thus, in sample 10, both particularly excellent effective capacitance and particularly excellent insulation reliability are achieved. The high average effective capacitance in sample 10 is considered to be achieved by the second concentration being low at 0.4 at % in sample 10, indicating that only a small amount of Fe is dissolved as a solid solution in the BaTiO₃ of the dielectric layers. The particularly long average failure time in sample 10 is considered to be achieved by: (1) the first concentration being high at 0.6 at %, which increases the Schottky barrier by the first intermediate layers 41 formed between the dielectric layers 11 and the first internal electrode layers 21; and (2) the Fe concentration ratio of the first concentration to the second concentration (C1/C2) being greater than 1, which prevents a strong electric field from being generated in the first intermediate layers 41 between the dielectric layers 11 and the first internal electrode layers 21 when voltage is applied.

In samples 12 to 21 (all examples), the average effective capacitance is high, ranging from −22% to −32%, and the average failure time is long, ranging from 4000 to 8000 minutes. Thus, in samples 12 to 21, both excellent effective capacitance and excellent insulation reliability are achieved. The high average effective capacitance in samples 12 to 21 is considered to be achieved by the low second concentration ranging from 0.1 at % to 0.8 at %, indicating that only a small amount of Fe is dissolved as a solid solution in the BaTiO₃ of the dielectric layers. The particularly long average failure time in samples 12 to 21 is considered to be achieved by: (1) the first concentration being high, ranging from 0.8 at % to 2 at %, which increases the Schottky barrier by the first intermediate layers 41 formed between the dielectric layers 11 and the first internal electrode layers 21; and (2) the Fe concentration ratio of the first concentration to the second concentration (C1/C2) being greater than 1, which prevents a strong electric field from being generated in the first intermediate layers 41 formed between the dielectric layers 11 and the first internal electrode layers 21.

In samples 22 and 25 (both comparative examples), the average failure time is long, ranging from 2,000 to 3,000 minutes, but the average effective capacitance is low, ranging from −41% to −50%. The low average effective capacitance in samples 22 and 25 is considered to be due to the second concentration being high, ranging from 1 at % to 1.3 at % in samples 22 and 25, indicating that a large amount of Fe is dissolved as a solid solution in the BaTiO₃ of the dielectric layers.

In samples 23 to 24 and 26 to 28 (all examples), the average effective capacitance is high, ranging from −23% to −35%, and the average failure time is long, ranging from 2000 to 3000 minutes. Thus, in samples 23 to 24 and 26 to 28, both excellent effective capacitance and excellent insulation reliability are achieved. The high average effective capacitance in samples 23 to 24 and 26 to 28 is considered to be achieved by the second concentration ranging from 0.1 at % to 0.9 at %, which is lower than 1.0 at %, indicating that only a small amount of Fe is dissolved as a solid solution in the BaTiO₃ of the dielectric layers. The long average failure time in samples 23 to 24 and 26 to 28 is considered to be achieved by: (1) the first concentration being high at 3 at %, which increases the Schottky barrier by the first intermediate layers 41 formed between the dielectric layers 11 and the first internal electrode layers 21; and (2) the Fe concentration ratio of the first concentration to the second concentration (C1/C2) being greater than 1, which prevents a strong electric field from being generated in the first intermediate layers 41 formed between the dielectric layers 11 and the first internal electrode layers 21.

In sample 29 (comparative example), the average effective capacitance is high at −35%, but the average failure time is short at 1000 minutes. The short average failure time in sample 29 is considered to be due to the high first concentration, which promotes the bonding of the excess Fe present in the intermediate layers with Ba or Ti of BaTiO₃, the main component of the dielectric layers. As a result, oxygen defects are generated in the BaTiO₃ of the dielectric layers, leading to an increase in leakage current caused by these oxygen defects.

The above results confirmed that samples in which the first concentration of Fe is from 0.2 at % to 5 at %, and the Fe concentration ratio is greater than 1 (samples 5 to 7, 10, 12 to 21, 23 to 24, and 26 to 28), exhibit average failure time of 2,000 minutes or more, indicating excellent insulation reliability. The first concentration of Fe ranging from 0.2 at % to 5 at % is considered to be achieved by the Schottky barrier increased by the first intermediate layers 41 formed between the dielectric layers 11 and the first internal electrode layers 21, and also achieved by the Fe concentration ratio of the first concentration to the second concentration (C1/C2) being greater than 1, which prevents a strong electric field from being generated in the first intermediate layers 41 formed between the dielectric layers 11 and the first internal electrode layers 21. On the other hand, when the first concentration is 0.15 at % or less (samples 1 to 4), the average failure time is 1,500 minutes or less, indicating a degraded insulation reliability. The reason why excellent insulation reliability cannot be achieved when the first concentration is 0.15 at % or less is considered to be either the absence of intermediate layers in which Fe is segregated, or the insufficient increase of the Schottky barrier between the dielectric layers and the internal electrode layers. When the first concentration of Fe is 6 at % or more (sample 29), the average failure time is 1,000 minutes, indicating that the insulation reliability has degraded. The reason why excellent insulation reliability cannot be achieved when the first concentration is 6 at % or more is considered to be that the excess Fe present in the intermediate layers bonds with Ba or Ti of BaTiO₃, the main component of the dielectric layers; as a result, oxygen defects are generated in the BaTiO₃ of the dielectric layers, leading to an increase in leakage current caused by these oxygen defects.

Among the examples, samples with the first concentration of 3 at % or less (samples 5 to 7, 10, 12 to 21, and 23 to 24) exhibit average failure time ranging from 2,300 to 8,000 minutes, whereas samples with the first concentration of 5 at % (samples 26 to 28) exhibit average failure time ranging from 2,000 to 2,500 minutes. Therefore, it was confirmed that the examples with the first concentration of 3 at % or less have better insulation reliability than those with the first concentration of 5 at %.

Among the examples, samples with the first concentration of 2 at % or less (samples 5 to 7, 10, and 12 to 21) exhibit average failure time ranging from 3000 to 8,000 minutes, whereas samples with the first concentration of 3 at % or higher (samples 23 to 24 and 26 to 28) exhibit average failure time ranging from 2,000 to 3000 minutes. Therefore, it was confirmed that the examples with the first concentration of 2 at % or less have better insulation reliability than those with the first concentration of 3 at % or higher. The tendency for insulation reliability to decrease (i.e., the average failure time to be shorter) when the first concentration exceeds 2 at % is considered to be due to the increased likelihood of bonding between the Fe abundantly present in the intermediate layers and Ba or Ti of BaTiO₃, the main component of the dielectric layers, resulting in oxygen defects generated in the BaTiO₃ within the dielectric layers 11.

Comparing the average failure time of sample 6 with that of sample 5, the average failure time of sample 6 is longer than that of sample 5, indicating that sample 6 has better insulation reliability. Comparing the parameters of sample 6 with those of sample 5, the first concentration of sample 6 is higher than that of sample 5, while the other parameters are the same. Therefore, it was confirmed that the example with the first concentration of 0.3 at % has better insulation reliability than the example with the first concentration of 0.2 at %. Further, comparing sample 10 with sample 13 confirmed that the example with the first concentration of 0.8 at % has better insulation reliability than the example with the first concentration of 0.6 at %, since the first concentration of sample 13 (0.8 at %) is higher than that of sample 10 (0.6 at %), while the other parameters are the same. Further, comparing sample 12 with sample 16 confirmed that the example with the first concentration of 0.9 at % has better insulation reliability than the example with the first concentration of 0.8 at %, since the first concentration of sample 16 (0.9 at %) is higher than that of sample 12 (0.8 at %), while the other parameters are the same.

Further, the examples with the second concentration of Fe less than 1 at % (samples 5 to 7, 10, 12 to 21, 23 to 24, and 26 to 28) were confirmed to exhibit an average effective capacitance of −35% or greater, indicating excellent effective capacitance. On the other hand, samples with the second concentration of Fe being 1 at % or higher (samples 9, 22, and 25) were confirmed to exhibit a small effective capacitance of −41% or less. The reason why the effective capacitance is small when the second concentration of Fe is 1 at % or higher is considered to be that a large amount of Fe is dissolved as a solid solution in the B-site of BaTiO₃ in the dielectric layers, thereby inhibiting polarization reversal at the B-site.

Among the examples, samples with the second concentration of 0.5 at % or less (samples 5 to 7, 10, 12 to 20, 23 to 24, and 26 to 27) exhibit an average effective capacitance ranging from −21% to −25%, whereas samples with the second concentration of 0.5 at % or higher (samples 15, 21, and 28) exhibit an average effective capacitance ranging from −26% to −35%. Therefore, it was confirmed that the examples with the second concentration of 0.5 at % or less have better effective capacitance than those with the second concentration of 0.6 at % or higher. The reason why the effective capacitance tends to be small when the second concentration is 0.6 at % or higher is considered to be that a larger amount of Fe is dissolved as a solid solution in the B-site of BaTiO₃ in the dielectric layers, thereby inhibiting polarization reversal at the B-site.

Based on the above, it was confirmed that samples with the first concentration of Fe ranging from 0.2 at % to 5 at %, the Fe concentration ratio of greater than 1, and the second concentration of less than 1 at % (samples 5 to 7, 10, 12 to 21, 23 to 24, and 26 to 28) have both excellent effective capacitance and excellent insulation reliability.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### Additional Embodiment 1

A capacitor comprising:
a body having:
a first internal electrode layer;
   a second internal electrode layer;
   a dielectric layer disposed between the first and second internal
   electrode layers in a first direction; and a first intermediate layer disposed between the first internal electrode
   layer and the dielectric layer, the first intermediate layer containing Fe at a first concentration;
a first external electrode provided on the body so as to be electrically connected to the first internal electrode layer; and
a second external electrode provided on the body so as to be electrically connected to the second internal electrode layer,
wherein the dielectric layer contains Fe at a second concentration,
wherein the first concentration is from 0.2 at % to 5 at %,
wherein the second concentration is less than 1 at %, and
wherein an Fe concentration ratio, which represents a ratio of the first concentration to the second concentration, is greater than 1.

### Additional Embodiment 2

The capacitor of Additional Embodiment 1, wherein the first concentration is 3 at % or lower.

### Additional Embodiment 3

The capacitor of Additional Embodiment 2, wherein the first concentration is 2 at % or lower.

### Additional Embodiment 4

The capacitor of any one of Additional Embodiments 1 to 3, wherein the first concentration is 0.3 at % or higher.

### Additional Embodiment 5

The capacitor of Additional Embodiment 4, wherein the first concentration is 0.8 at % or higher.

### Additional Embodiment 6

The capacitor of any one of Additional Embodiments 1 to 5, wherein the second concentration is 0.5 at % or lower.

### Additional Embodiment 7

The capacitor of any one of Additional Embodiments 1 to 6, wherein a main component of the first internal electrode layer and the second internal electrode layer is Ni.

### Additional Embodiment 8

The capacitor of any one of Additional Embodiments 1 to 7, wherein the body further includes a second intermediate layer disposed between the second internal electrode layer and the dielectric layer, the second intermediate layer containing Fe at a concentration ranging from 0.2 at % to 5 at %.

### Additional Embodiment 9

A circuit module comprising the capacitor of any one of Additional Embodiments 1 to 8.

### Additional Embodiment 10

An electronic device including the circuit module of Additional Embodiment 9.

### Additional Embodiment 11

A method of manufacturing a capacitor comprising the steps of:
preparing a compact including a dielectric green sheet and internal electrode patterns provided on a first surface and a second surface of the dielectric green sheet, the internal electrode patterns containing Ni and Fe;
performing a first heating process in which the compact is heated at a first temperature to form a segregation layer between the dielectric green sheet and each of the internal electrode patterns, the segregation layer containing Fe segregated therein; and
performing a second heating process in which the compact heated in the first heating process is heated at a second temperature, the second temperature being higher than the first temperature.

What is claimed is:

1. A capacitor comprising:
a body having:
a first internal electrode layer;
a second internal electrode layer;
a dielectric layer disposed between the first and second internal electrode layers in a first direction; and
a first intermediate layer disposed between the first internal electrode layer and the dielectric layer, the first intermediate layer containing Fe at a first concentration;
a first external electrode provided on the body so as to be electrically connected to the first internal electrode layer; and
a second external electrode provided on the body so as to be electrically connected to the second internal electrode layer,
wherein the dielectric layer contains Fe at a second concentration,
wherein the first concentration is from 0.2 at % to 5 at %,
wherein the second concentration is less than 1 at %, and
wherein an Fe concentration ratio, which represents a ratio of the first concentration to the second concentration, is greater than 1.

2. The capacitor of claim 1, wherein the first concentration is 3 at % or lower.

3. The capacitor of claim 2, wherein the first concentration is 2 at % or lower.

4. The capacitor of claim 1, wherein the first concentration is 0.3 at % or higher.

5. The capacitor of claim 4, wherein the first concentration is 0.8 at % or higher.

6. The capacitor of claim 1, wherein the second concentration is 0.5 at % or lower.

7. The capacitor of claim 1, wherein a main component of the first internal electrode layer and the second internal electrode layer is Ni.

8. The capacitor of claim 1, wherein the body further includes a second intermediate layer disposed between the second internal electrode layer and the dielectric layer, the second intermediate layer containing Fe at a concentration ranging from 0.2 at % to 5 at %.

9. A circuit module comprising the capacitor of claim 1.

10. An electronic device comprising the circuit module of claim 9.

11. A method of manufacturing a capacitor comprising the steps of:
preparing a compact including a dielectric green sheet and internal electrode patterns provided on a first surface and a second surface of the dielectric green sheet, the internal electrode patterns containing Ni and Fe;
performing a first heating process in which the compact is heated at a first temperature to form a segregation layer between the dielectric green sheet and each of the internal electrode patterns, the segregation layer containing Fe segregated therein; and
performing a second heating process in which the compact heated in the first heating process is heated at a second temperature, the second temperature being higher than the first temperature.
